(19) United States
(12) Patent Application Publication
(10) Pub. No.: US 2002/0178190 A1
(43) Pub. Date: Nov. 28, 2002

(54) Systems and methods for integrating mainframe and client-server data into automatically generated business correspondence

(76) Inventors: Allison Pope, Raleigh, NC (US); Kristin Simora, Raleigh, NC (US)

Correspondence Address: PRIEST & GOLDSTEIN PLLC, 5015 SOUTHPARK DRIVE, SUITE 230, DURHAM, NC, 27713-7736, US

(21) Appl. No.: 09/862,210

(22) Filed: May 22, 2001

(51) Int. Cl. G06F 17/24

(52) U.S. Cl. 707/530; 707/517

(57) ABSTRACT

Systems and techniques are described for automatically generating correspondence documents. One system is described that includes a web server for generating web pages that are transmitted for remote viewing using a client browser. The generated web pages are configured to include a document selection section for identifying a type of correspondence to be generated and an input variables section for identifying a subject of the correspondence. The system further includes a transaction server connected to the web server for receiving inputs from the web server and, in response to those inputs, automatically retrieving necessary data and a document template and, using the retrieved data and document template, generating a document that is transmitted back to the user for viewing and editing.

### BACKGROUND OF THE INVENTION

1. Field of the Invention

The present invention relates generally to improvements to systems and methods for automatically generating business correspondence, and more particularly to advantageous aspects of systems and methods for integrating mainframe and client-server data into automatically generated business correspondence.

2. Description of the Prior Art

An important part of many business enterprises is the preparation of correspondence to be sent to customers. The preparation of a piece of correspondence typically requires many steps. First, an employee must assemble any necessary data, including data specific to the customer to whom the correspondence is to be sent. Then, the employee must integrate the assembled data into a suitable letter format. After the letter is composed, it must be printed and signed. Finally, the letter is transmitted to the customer, using standard mail, e-mail, fax, or some other suitable technique.

In certain industries, such as banking and insurance, much of the correspondence is highly repetitive in nature, such as responding to routine customer inquiries. Because of the great value of human resources to an organization, there is an ongoing need for systems and methods that streamline the correspondence function, thereby-increasing the efficiency of the workforce.

### SUMMARY OF THE INVENTION

The above-described issues and others are addressed by the present invention, one aspect of which provides a web-based system for automatically generating correspondence. The system includes a web server for generating web pages that are transmitted for remote viewing using a client browser. The generated web pages are configured to include a document selection section for identifying a type of correspondence to be generated and an input variables section for identifying a subject of the correspondence. The system further includes a transaction server connected to the web server for receiving inputs from the web server and, in response to those inputs, automatically retrieving necessary data and a document template and, using the retrieved data and document template, generating a document that is transmitted back to the user for viewing and editing.

Additional features and advantages of the present invention will become apparent by reference to the following detailed description and accompanying drawings.

### BRIEF DESCRIPTION OF THE DRAWINGS

FIG. 1 shows a diagram of an automatic correspondence generation system according to a first aspect of the invention.

FIG. 2 shows a diagram of a further embodiment of an automatic correspondence generation system according to the present invention.

FIG. 3 shows a screenshot of a logon screen according to a further aspect of the invention.

FIG. 4 shows a screenshot of a home page for a website at which various systems are implemented, including a system according to the invention.

FIG. 5 shows a screenshot of the main page for an automatic correspondence generation system according to the present invention.

FIG. 6 shows a screenshot of the main page shown in FIG. 5, further including a document selection section.

FIG. 7 shows a screenshot of the main page shown in FIG. 5, further including an input variables section.

FIG. 8 shows a screenshot of a web page containing a correspondence document that has been automatically generated in accordance with the present invention.

FIG. 9 shows a screenshot of the web page shown in FIG. 8, in which the web page has been scrolled down to display the lower portion of the generated document.

FIG. 10 shows a screenshot of a Print menu for printing or faxing that has been automatically generated by the present invention.

FIG. 11 shows a screenshot of a document maintenance section in accordance with a further aspect of the present invention.

FIG. 12 shows a screenshot of an upload document screen that is used to upload a document upon which a maintenance function has been performed.

FIG. 13 shows a screenshot of a capitalization maintenance section in accordance with a further aspect of the present invention.

FIG. 14 shows a screenshot of an error notification screen according to a further aspect of the present invention.

FIG. 15 shows a diagram of an installation of the major software components of a system according to the present invention into various hardware components of a web-based network.

### DETAILED DESCRIPTION

A first aspect of the present invention provides web-based systems and methods, herein collectively referred to as the New Office Vision Application (“NOVA”) that automatically integrates mainframe and client-server data into automatically generated business letters and other types of correspondence that can be edited and then sent from a business enterprise to its customers. The data that can be automatically integrated into the generated correspondence includes customer-specific data, as well as data identifying the author of the letter. In addition, further aspects of the invention provide for the inclusion of the enterprise's logo and watermark and a graphical image of author's signature in the generated document, as well as automated faxing, e-mailing, and printing of the document.

It will be apparent that the NOVA system, as described herein, can significantly reduce the time required to generate correspondence, as well as associated costs, such as paper. In addition, the NOVA system enables multi-channel delivery. Also, a further aspect of the NOVA provides an improved system for the maintenance of documents and user information, enabling real-time modifications to take place. It should also be noted that documents generated by the NOVA system can be stored directly in electronic form, providing the business with a soft copy of the exact document that went out. This feature can be used to save on printing and imaging costs.

It should be noted that the NOVA system was developed for use in the mortgage insurance industry. However, it will be apparent that the system may be modified for use in other industries without departing from the spirit of the invention.

Unlike some earlier systems used to perform an automatic correspondence function, the NOVA system integrates mainframe and client-server data, and can be run with or without processing mainframe data. As mentioned above, documents generated by the NOVA system can be faxed, e-mailed, or printed with simple user selections, and the NOVA system is able to insert a graphical image of the author's signature, if desired. Additionally, the present embodiment of the NOVA system generates correspondence in the form of Microsoft Word documents. As described below, because Microsoft Word is seamlessly integrated into the web browser used to access the NOVA system, the functions of editing and maintaining letters are very simple. According to a further aspect of the invention, the NOVA system is integrated into a single sign-on security system for other applications in the business.

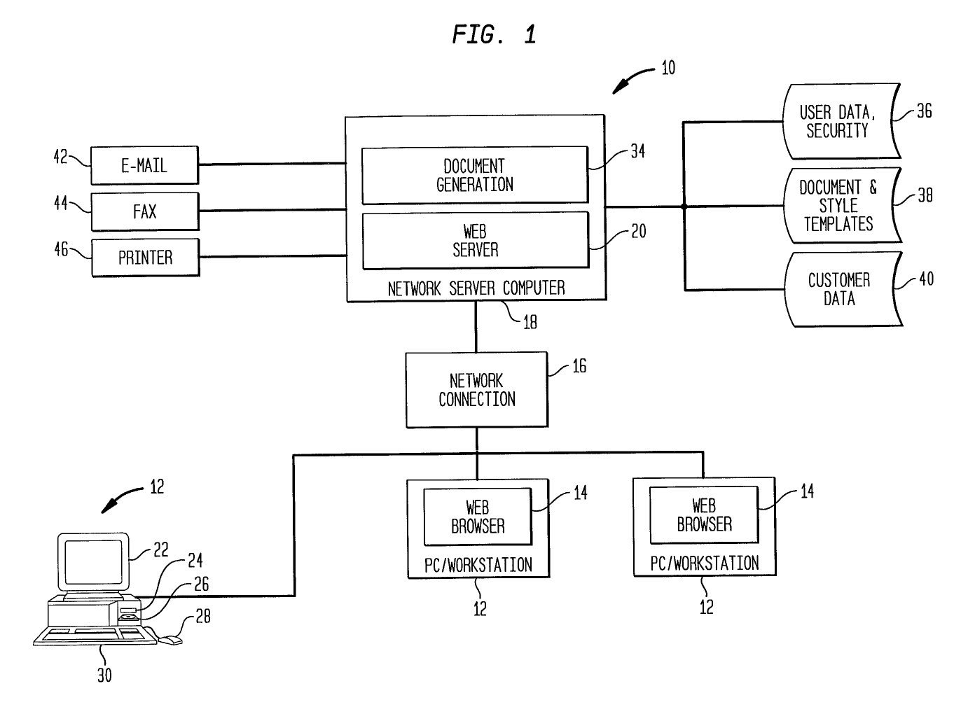

FIG. 1 shows a diagram of a first embodiment of the NOVA system 10. In this embodiment, the NOVA system is implemented using a web-based configuration, in which a network of personal computers or workstations 12 running a web browser software 14, is connected using the Internet or other network connection 16 to a central network server computer 18 running a web server software 20. The personal computers 12 in the network form the “front end” of the NOVA system, that is, the portion of the system that is actually seen by users of the system. The server computer 16 and associated components, described below, form the “back end” of the NOVA system.

As shown in FIG. 1, each personal computer or workstation 12 in the network includes a number of input and output devices, such as a monitor 22, floppy diskette drive 24, CD-ROM drive 26, keyboard 28, and mouse 30. It should be noted that although a desktop computer is shown in FIG. 1, the front end of the NOVA system may be run on other suitable devices, such as a laptop, a personal digital assistant, and the like. The NOVA system may be implemented entirely within a business organization's firewall, or may also be implemented such that the system is accessible from outside of the business organization through an Internet connection.

The server computer 20 includes document generation software 34 that automatically generates business correspondence based upon inputs received at a personal computer 12 in the network. In performing the functions of the NOVA system 10, the server computer 20 has access to various databases 36-40, which may be located on the server computer 20 or may be located on other computers connected to the network. These databases include a first database 36 containing information relating to the user of the NOVA system and system security, a second database 38 containing document and style templates, and a third database 40 containing customer data.

The server computer 18 further has access to e-mail and fax facilities 42 and 44 for automatically transmitting a piece of correspondence to a customer. Alternatively, correspondence may be printed out at a network printer 46. In an alternative embodiment of the invention, it would also be possible for the correspondence to be printed out on a local printer connected directly to the user's personal computer or workstation 12.

The general operation of the present embodiment of the NOVA system can be summed up as follows. The personal computer 12 is operated by an employee of the business organization. In generating correspondence, the employee enters suitable inputs into a web page that is displayed on the computer monitor 22. These inputs include, for example, the desired style of the document to be generated, a description of the type of document to be generated, and information identifying the customer to whom the correspondence is to be addressed.

Once the information has been entered into the web page, the back-end of the NOVA system generates the requested document in the form of a Microsoft Word document, which is displayed to the user. Depending upon the style selected by the user, this document may be on letterhead, may bear a watermark, and may also bear a graphical image of a signature. The user edits the document, if needed. Once the document is in final form, the user then provides an input to the NOVA system, causing the system to complete the processing of the document. The NOVA system may, at the user's option, email or fax the document to a designated recipient. Alternatively, the document may be printed out in hard copy form at a local or network printer 46 for mailing to the addressee using conventional mail.

Thus, the present invention represents a significant improvement in the way that the correspondence function is handled. The present invention streamlines the process such that an employee no longer has to laboriously gather information and incorporate that information into a form letter. Rather, simply by making appropriate menu selections on a series of web pages, correspondence is generated accurately and quickly, finalized, and sent to the addressee.

As described below, the NOVA system includes a number of other useful features. These include a document maintenance function, in which the user may modify existing document templates or create new ones, and a capitalization function, in which the user may dynamically update a list of names having unusual capitalization patterns.

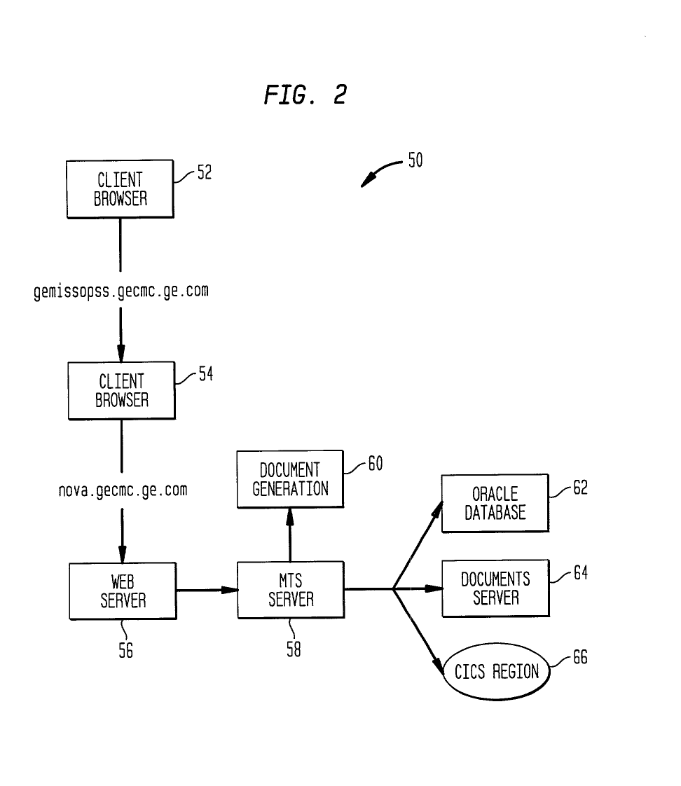

FIG. 2 shows a diagram of a further embodiment of a NOVA system 50 according to the present invention. As illustrated in FIG. 2, the NOVA system is accessed by using a first client browser 52 to access a home page having a Universal Resource Locator (“URL”). In the example shown, the URL is gemissopss.gecmc.ge.com. From the home page, a second client browser 54, which may or may not be the same as the first client browser 52, is used to access the main page of the NOVA system, which has the URL nova.gemc.ge.com. In the present embodiment of the invention, the client browser is Microsoft Internet Explorer, version 4.0 and higher. The NOVA system is also completely coded to Netscape Navigator 4.0 and higher. Thus, wherever the present description refers to a “client browser” or to Microsoft Internet Explorer, it will be appreciated that the description also refers to Netscape Navigator.

In the present embodiment of the invention, the NOVA system is implemented as an Active Server Page (ASP) that displays HTML generated on the MTS server 58, where it is viewed using the client browser 54. The ASP is used to gather inputs from, and provide outputs back to, the user.

The web server 56 passes inputs received from the user to a transaction server 58. In the present embodiment of the invention, the transactions server 58 is a Microsoft Transaction Server (“MTS”). The transactions server 58 performs a number of functions, including invoking a document generation module 60 for the automatic generation of the requested correspondence.

More specifically, in the present embodiment of the invention, document generation 60 and other functions of the NOVA system are performed by programming objects that are loaded into the transactions server 58 in the form of Dynamic Link Libraries (“DLLs”). These programming objects are written in Visual Basic.

In order to perform various functions of the NOVA system, the transactions server 58 is provided with access to data, including both data relating to a particular customer, as well as data needed for security purposes, such as the user's identifier (id) and password. In the present embodiment of the invention, user data and security-related data are stored in an Oracle database 62, and customer data is stored in a Customer Information Control System (“CICS”) region 66. It is also possible to use NOVA with systems in which all of the required data is stored in a single type of database, as well as in system using other types of databases, including Sybase, SQL Server, DB2, and the like, or combinations of different types of databases. The transactions server 58 is also provided with access to document templates and document styles, which are stored on a documents server 64.

In operation, the transactions server 58 uses data from the Oracle database 62 to confirm that the user is authorized to use the NOVA system. Once authorization has been confirmed, the transactions server 58 accesses the selected document template and style from the documents server 64, and populates the template with data retrieved from the CICS region 66. The generated document is then provided back to the user through the web server 56 and client browser 54. In the present embodiment of the invention, the document is provided in the form of a Microsoft Word document. Microsoft Word is integrated with Microsoft Internet Explorer, so from the user's point of view, the viewing and editing functions are seamless. The generated piece of correspondence appears in the client browser as an editable document, without requiring the opening of another program.

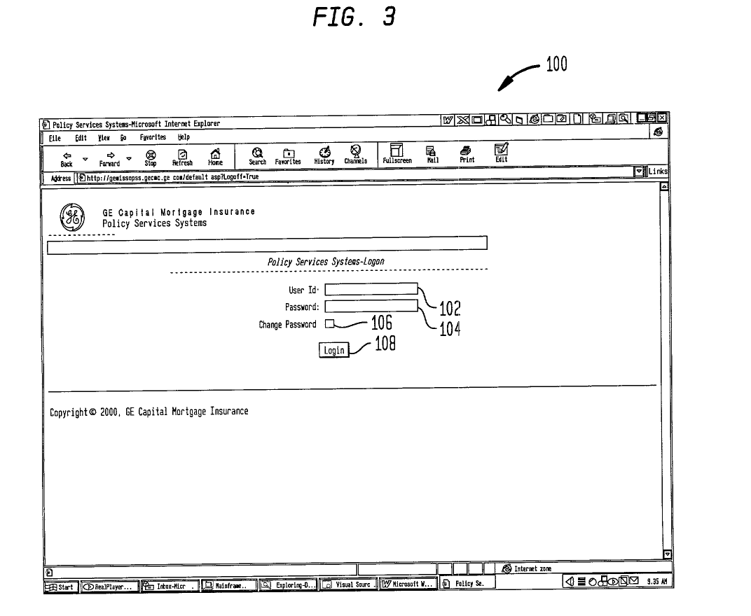

FIGS. 3 through 14, discussed below, illustrate exemplary web pages and display screens that may advantageously be used by the NOVA system to receive inputs from, and provide outputs to, the user. It will be appreciated that these web pages may be modified without departing from the spirit of the invention.

FIG. 3 shows a login screen 100 used in the present embodiment of the NOVA system. This is the screen that first appears when the user of the NOVA system accesses the website gemissopss.gecmc.ge.com from the user's personal computer. The login screen 100 includes a first data entry box 102 for receiving the user's name or other identifier and a second data entry box 104 for receiving the user's password. A checkbox 106 is provided, if the user wishes to change his or her password. Once the data entry boxes 102 and 104 have been completed, the user clicks on the command button 108 labeled “Login.”

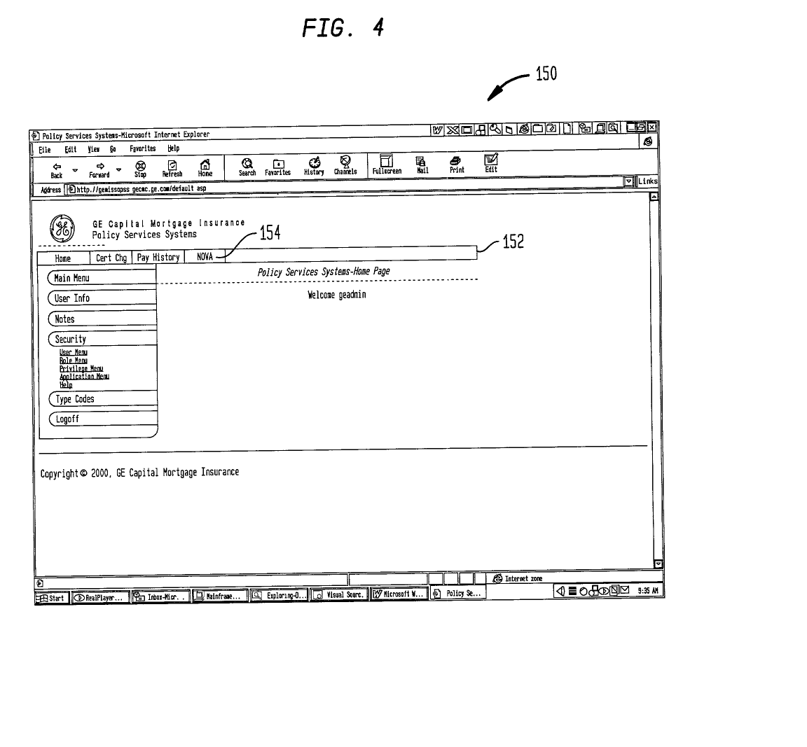

If the login function has been successfully completed, the user is then transferred to the web page 150 shown in FIG. 4. This web page 150 provides access to various systems that are available at the website, including the NOVA system. A navigation bar 152 is provided that includes a number of buttons, including a button 154 labeled “NOVA.” When a user clicks on the NOVA button 154, the user is transferred to the home page for the NOVA system at nova.gemc.ge.com.

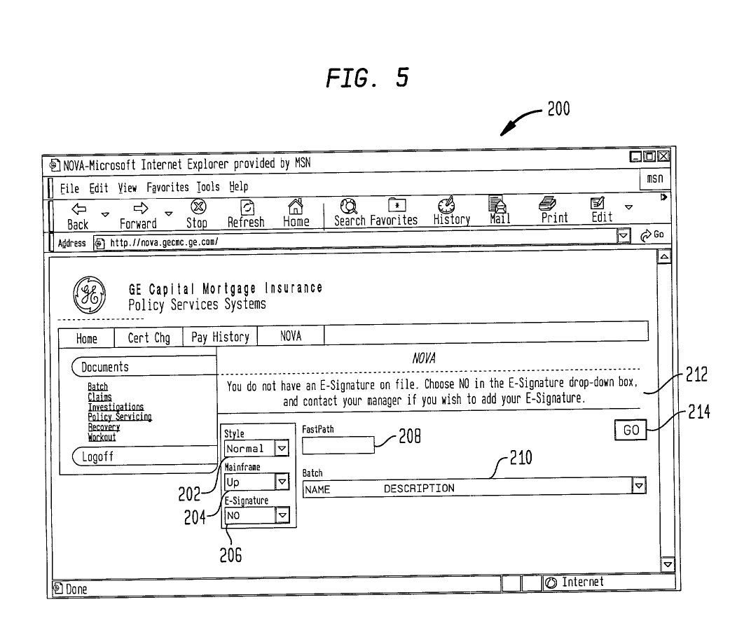

FIG. 5 shows a screenshot of the NOVA system home page 200, which is accessed by clicking on the NOVA button 154 in the web page shown in FIG. 4. The NOVA home page includes a number of data entry boxes for providing information to the NOVA system. These data entry boxes include Style 202, Mainframe 204, E-Signature 206, Fast Path box 208, and Batch 210. As described in further detail below, the Style, Mainframe, E-Signature and Batch boxes are provided with drop-down menus to facilitate rapid and accurate input of data.

In addition, the NOVA home page 200 includes a text portion 212. The text portion 212 may include, for example, notes or instructions to the user. In FIG. 5, the text portion 212 indicates that the user does not have an E-Signature on file. Other messages may appear, as needed.

When the user clicks on the downward-pointing arrow at the right side of the Style box 202, the user is presented with a drop-down box containing four pre-configured Style options: Normal, Fax, E-mail, and Plain. The Normal option is selected when the user wishes to create an electronic document that looks like it was printed onto the organization's stationery, or alternatively to print a hard copy of the generated correspondence onto a blank sheet of paper. When the Normal option is selected, the document is generated using a style template that includes the organization's logo, letterhead, and watermark.

The Fax option is selected when the user wishes to create an electronic document that is to be faxed to the intended recipient. The generated document can be faxed directly from an electronic file or can be printed out first onto a sheet of blank paper. When the Fax option is selected, the document is generated using a style template that includes the organization's logo and letter. However, because the watermark may become blurred when faxed, it is omitted in this particular style.

The E-mail option is selected when the user wishes to e-mail the generated document to the recipient. When the E-mail option is selected, the document is generated using a style template that includes the organization's logo, letterhead in color, and watermark.

The Plain option is selected when the user wishes to print the generated document onto a piece of the organization's stationery, typically bond letterhead. Because the organization's stationery already includes the organization's logo, letterhead, and watermark, no style components need to be added to the generated document.

When the user clicks on the downward pointing arrow at the right side of the Mainframe box 204, the user is presented with a drop-down box containing two options: Up or Down. In the Up mode, the system retrieves customer data from the mainframe for insertion into the generated piece of correspondence. In the Down mode, the system generates a requested piece of correspondence without inserting specific customer data.

When the user clicks on the downward pointing arrow at the right side of the E-signature box 206, the user is presented with a drop-down menu containing two options: Yes or No. In the Yes mode, the NOVA system inserts a previously stored graphical image of the user's signature at an appropriate position in the generated letter. In the No mode, the NOVA system leaves a blank space in the generated document. This option may be used, for example, where the generated document is to be printed locally onto letterhead, and the user wishes to sign the generated document by hand.

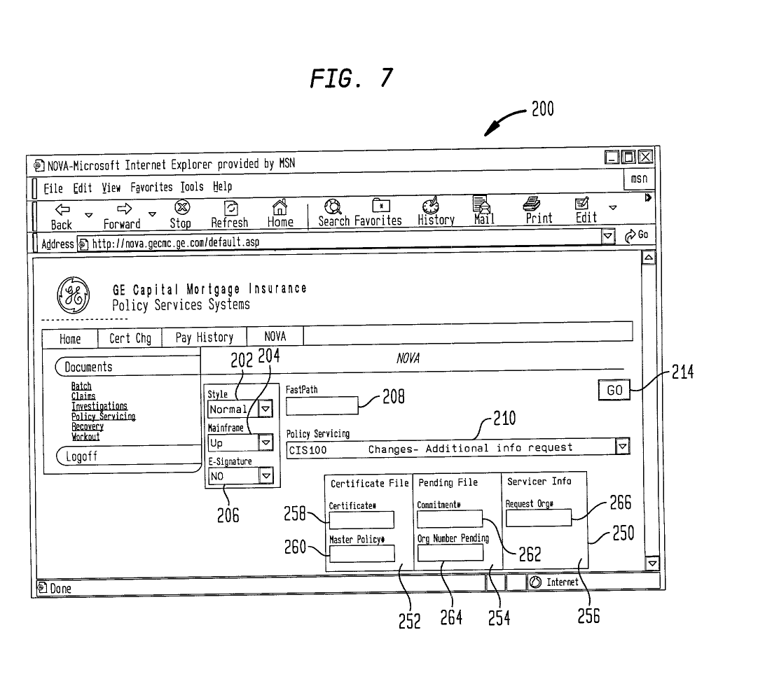

The Fast Path box 208 is used when the user already knows the name of the type of correspondence to be generated. Typing the name into the Fast Path box 208 brings the user directly to the input variables screen for that document, shown in FIG. 7, discussed below.

Alternatively, if the user does not already know the name of the type of correspondence to be generated, the user clicks on the downward pointing arrow on the right side of the Batch box 210 and is presented with a drop-down box containing the document names and descriptions of all of the types of letters that the person logged in is allowed to access. Thus, the contents of the Batch drop-down box will vary, depending upon the identity of the user.

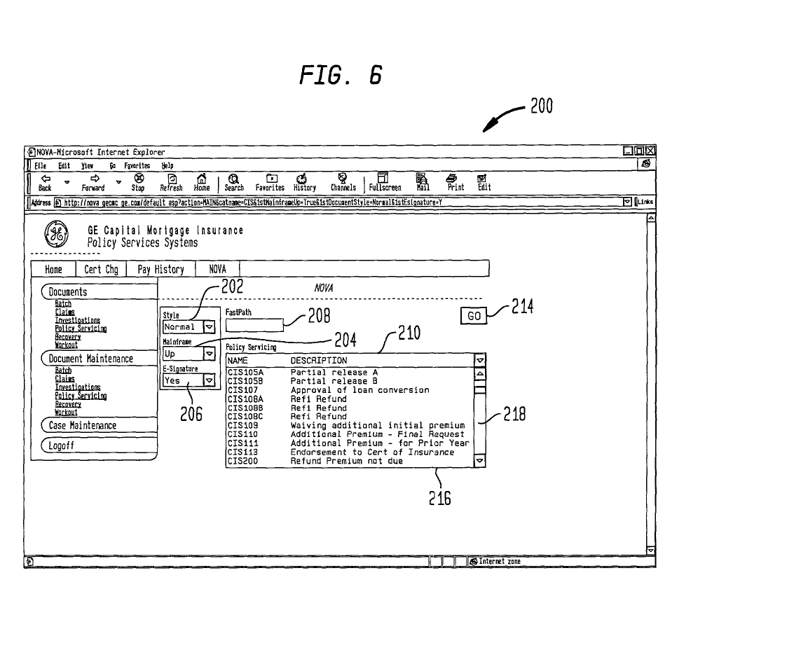

FIG. 6 shows a screenshot of the NOVA main page 200, in which the user has clicked on the downward pointing arrow at the right side of the Batch box 210. As shown in FIG. 6, clicking on the arrow causes a drop down box 216 to appear, which contains a list of documents accessible by the user. The user may navigate up and down this list of documents using the scroll bar 218 at the right side of the drop down box 216. Once the desired document has been located, the user highlights the document name by clicking on it.

As shown in FIG. 7, identifying the desired document type, either by using the Fast Path box 208 or the Batch box 210 causes the name and description of the document to appear in the Batch box 210. For the purposes of illustration, the particular document that has been selected in FIG. 7 is identified as “CIS 100 Changes—Additional info request.” This letter is used in a situation in which the customer has requested changes to a loan, but has not provided sufficient information to the mortgage company to allow a decision to be made. The letter generated by the NOVA system in response to the request includes a restatement of the requested changes and a list of additional information to be provided by the borrower.

Once the document type has been identified, an input variables section 250 appears at the bottom of the NOVA main screen 200. The information that is entered into the input variables section 250 is used to identify the particular customer, transaction or other information relating to the correspondence to be generated to allow the system to retrieve necessary data from the mainframe. In the present embodiment of the invention, the input variables section 250 includes three divisions, labeled Certificate File 252, Pending File 254, and Service Info 256. These particular divisions reflect types of data stored on a mainframe computer at a mortgage insurance company. It will be apparent that the input variables section 250 may be modified to suit other types of data and other industries without departing from the spirit of the invention.

The Certificate File division 252 of the input variables section 250 is used if the borrower's record is in a certificate file stored on the mainframe. In the present embodiment of the invention, a single certificate file is stored on the mainframe. However, it would also be possible to use the present invention in conjunction with a plurality of certificate files. The user enters the insurance certificate number in the Certificate File box 258. If desired, the user may also enter the master policy number in the Master Policy Number box 260.

The Pending File division 254 of the input variables section 250 is used if the borrower's record is in a pending file stored on the mainframe. In the present embodiment of the invention, a single certificate file is stored on the mainframe. However, it would also be possible to use the present invention in conjunction with a plurality of pending files. Depending upon the information available to the user of the NOVA system, the user enters the commitment number in the Commitment Number box 262. If desired, the user may also enter the organization number in the Organization Number Pending box 264.

The Servicer Info division 256 of the input variables section 250 is used to generate a document using a lender's organization number, which is entered into the Requesting Organization Number box 266. Entering information into this box causes the NOVA system to generate a document in which the data fields are populated with lender information, but without data specific to any particular borrower.

Once a set of input variables has been entered, the user either strikes the Enter Key on the user's computer keyboard, or alternatively clicks on the GO button 214. This causes the NOVA system to generate the requested letter.

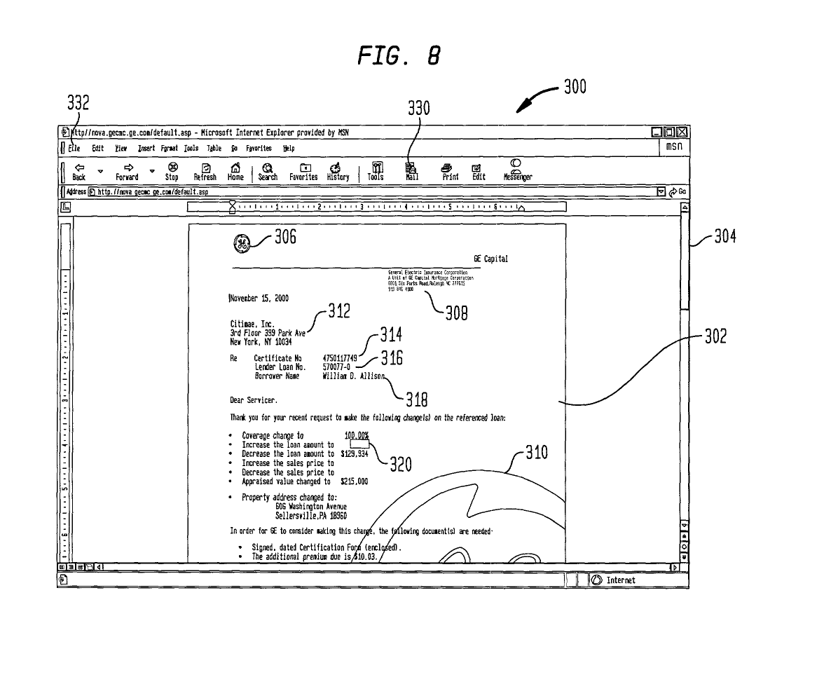

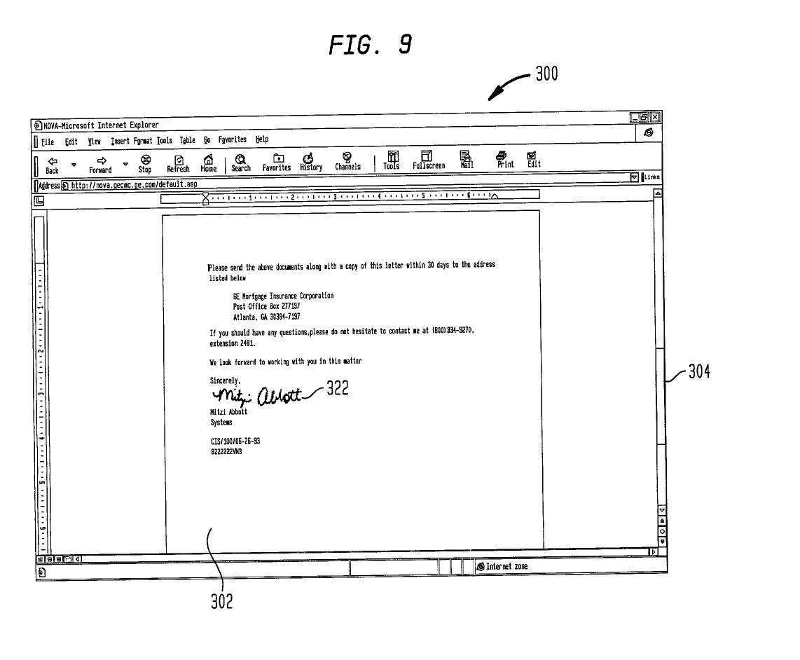

FIG. 8 shows a screenshot of a web page 300 containing a document 302 that has been generated by the NOVA system, based upon a set of input variables entered into the input variables section shown in FIG. 7. As discussed above, the particular document generated in this example is the document identified as “CIS100 Changes—Additional info request.” The document 302 is generated in the form of a Microsoft Word document, in which the data retrieved by the NOVA system is merged with the document and style templates. The user navigates within the document by using the scrollbar 304 appearing at the right side of the screen. FIG. 9 shows a screenshot of the web page 300 shown in FIG. 8, in which the user has scrolled to the end of the generated document 302.

The generated letter 302 shown in FIG. 8 was prepared using the Normal style. As described above, the Normal style includes the business's logo 306, letterhead 308, and watermark 310. The letter 302 has been automatically populated with data from the mainframe. In the present example, this data includes the address of the recipient 312, the certificate number 314, the lender loan number 316, the borrower name 318, and the like.

In this particular letter, the first paragraph in the body of the letter includes a list that restates the changes to the loan that have been requested by the customer. This list includes headings such as “Coverage change to,” “Increase the loan amount to,” “Decrease the loan amount to,” and the like. Each of these headings is followed by a data field that is automatically populated by the NOVA system using data retrieved from the mainframe, including any data recently generated in analyzing or processing the customer's request. Here, not all of the headings in the list are relevant. Accordingly, the data fields after certain headings are blank. A gray box 320 is provided as a visual cue for data fields to be filled in by the user of the NOVA system. The gray box 320 indicates a field that was not populated in the generated letter 302 because a particular piece of data was not found in the database. As further shown in FIG. 8, the second paragraph in the body of the generated letter includes a list of additional documents to be provided by the customer. This list of additional documents is automatically generated, based upon data contained in the document template.

Based upon the user's login ID, the NOVA system also populates the letter with specific employee information that has been previously stored in a user profile. This information is used to personalize the generated document and includes, for example, the user's telephone number, name, department name, fax number. As shown in FIG. 9, if the user has stored his or her signature in the NOVA system and selected the Yes option in the E-signature box 206 on the main NOVA page 200, a graphical image of the signature 322 is also merged into the generated document.

As mentioned above, the present embodiment of the invention uses Microsoft Internet Explorer as the client browser. Because Microsoft Word is integrated with Microsoft Internet Explorer, the generated document appears in fully editable form on the client browser screen. In other words, the user of the system does not have to call up a separate word processing program in order to edit the generated document. Thus, the generated document 302 is completely editable by the user. The user may change the fonts, spelling, wording, and the like. In addition, the user may delete headings or other fields that are not relevant to the current response.

After the user has made any desired edits to the generated document, the user then may use the NOVA system to send the completed correspondence to the desired recipient, or recipients. If the generated document is to be sent by e-mail, the user may do so by using the web browser's e-mail function. In the present embodiment of the invention, the Internet Explorer e-mail function is accessed by clicking on the appropriate symbol 330 at the top of the screen.

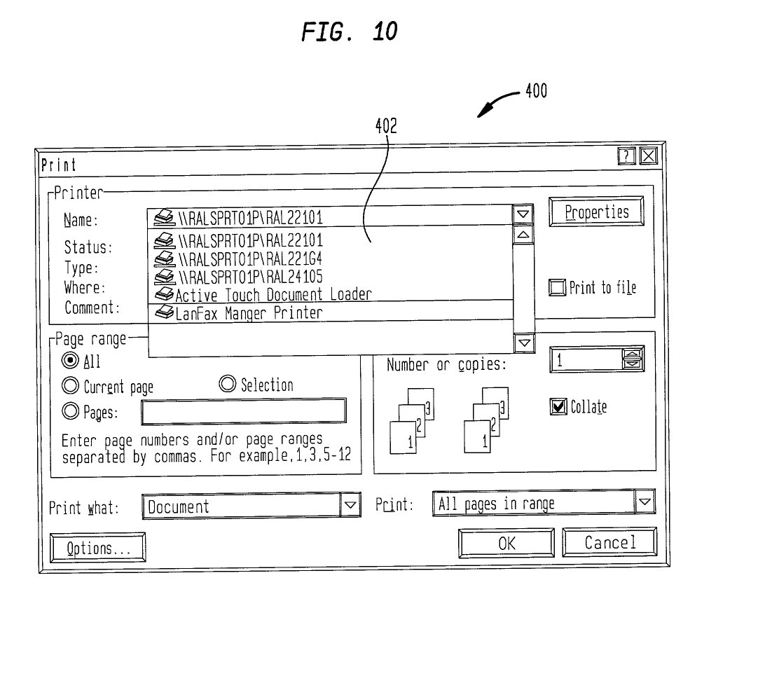

If the user wishes to send the completed document by fax, or wishes to print the document locally, the user selects the File option 332 from the Internet Explorer navigation bar, and then selects the Print option from the File drop-down menu. Internet Explorer then generates a Print screen 400, shown in FIG. 10, which provides the user with a menu of options 402 for processing the completing document. These options include, for example, printing the document to a designated printer, or faxing the document. It should also be noted that documents may be saved to a local or network drive by selecting the Save As option from the File drop-down menu.

If the generated letter is to be faxed, the user generates the letter, chooses the Print option from the File drop-down menu, and selects a fax manager as the printer. The present embodiment of the invention uses Alcom's LanFax Manager as a fax manager. The fax manager will automatically spawn a cover page, and the generated document will be faxed to the recipient's fax number.

A further aspect of the NOVA system provides an “Instant” feature that allows an outside web application to generate letters without having to go through the normal NOVA interface. The outside web application sends all of the data required to generate the document to NOVA through request parameters in the web browser. The use of request parameters in the web browser replaces the main NOVA screen, illustrated in FIG. 5 and discussed above, where user chooses formatting options and what document to generate. The “Instant” feature allows for data from any source to be used, such as Oracle or Sybase. The NOVA system does not require that users of the outside application to be a user of the NOVA system in order to user the “Instant” feature. The outside application does a simple login in the background to access the “Instant” feature.

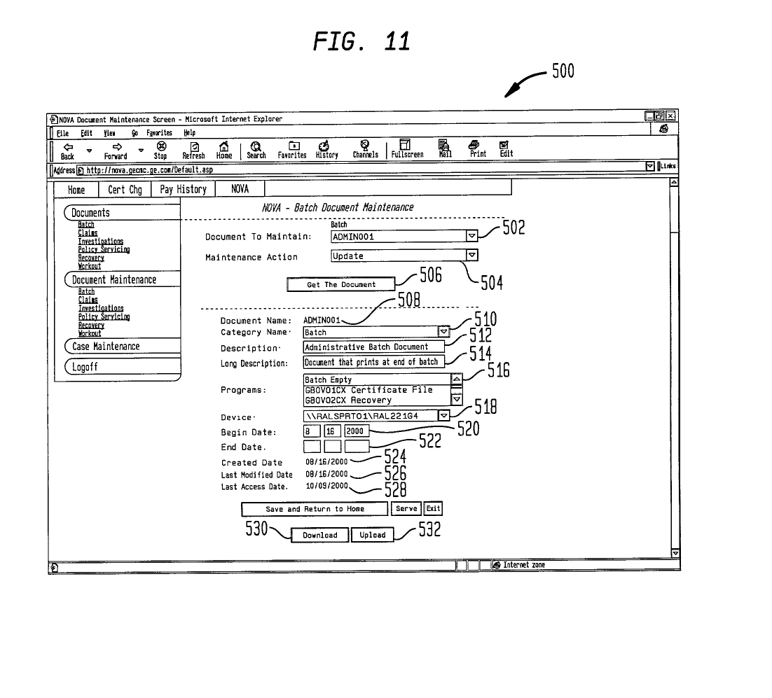

FIG. 11 shows a screenshot of a the document maintenance section 500 of the present embodiment of the NOVA system. The document maintenance section 500 is used to perform various maintenance functions on document templates used by the NOVA system in generating correspondence. As shown in FIG. 11, the document maintenance section 500 contains a number of data entry boxes, described below.

The “Document to Maintain” data entry box 502 provides a drop-down menu that allows the user to select the template for which the maintenance function is to be performed.

The “Maintenance Action” data entry box 504 provides a drop-down menu that allows the user to select the action to be performed. The menu options include: View, Update, Insert, and Model After. Selecting the View option causes the system to display all information for the selected document, and is not editable. Selecting the Update option causes the system to display all information for the selected document, and is editable. Selecting the Insert option causes the system to display a new document in which all the fields are blank, in order to create a new document. Selecting the Model After option causes the system to display a document in which the fields are filled in from an existing document, but will be saved for a new document.

Once the user has identified the document to maintain and the maintenance action to be performed, the user then clicks on the button labeled “Get the Document.” This brings up the information shown on the bottom half of the screen.

The Document Name field 508 shows the name of the document to be viewed, edited, or added. The Category Name field 510 shows the category to which the document is assigned. The Description field 512 shows the name of the document, which appears at the bottom of the generated letter. The Long Description field 514 shows the description of the document that will be viewed when selecting a document. The Programs field 516 determines what input variables may be used to generate the document. The Device field 518 shows the default printer to be used for batch documents. The Begin Date field 520 shows a date on or after which the letter may be used. The End Date field 522 shows a date on or before which the letter may be used. The Created Date field 524 shows the date upon which the template was created. The Last Modified Date field 526 shows the date upon which the template was last modified. The Last Access Date field 528 shows the date upon which the template was last used, and may be used as a guide for deleting old letters.

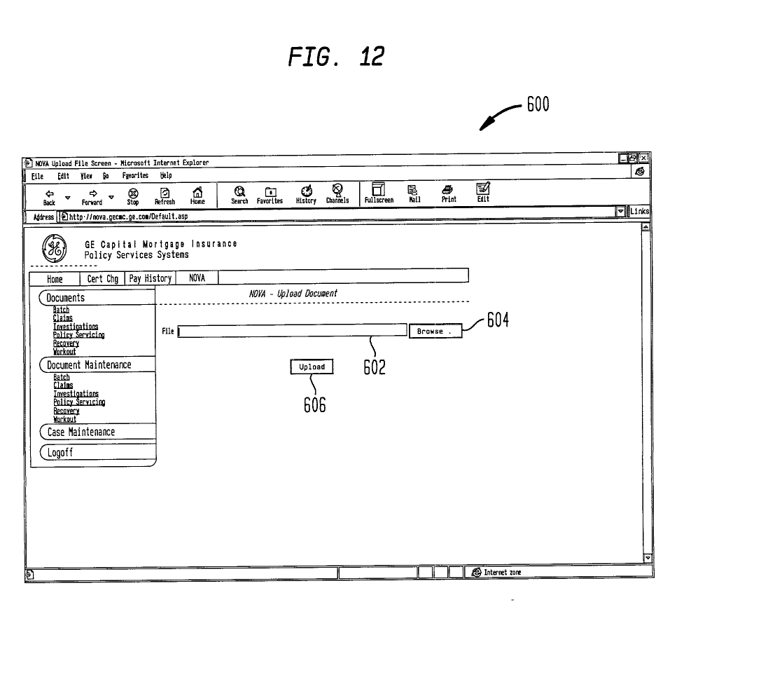

Clicking on the Download button 530 retrieves the template in order for the user to make changes to the template. Once a user downloads a document and makes changes, the document needs to be uploaded back to the production server. Clicking on the Upload button 532 brings up the Upload Document screen 600 shown in FIG. 12. The user either enters the name of the document directly into the data entry box 602 labeled “File” or else clicks on the Browse button 604 to locate the file either on a local drive or elsewhere in the network. Once the document has been entered into the File box, the user clicks on the Upload button 606, which causes the old document stored in the NOVA system document server to be replaced by the changed document.

As mentioned above, the NOVA system also provides a capitalization maintenance function, which is used to define character strings in generated documents for proper nouns that do not follow a normal capitalization scheme, with an initial uppercase letter followed by all lowercase letters. Examples of special capitalization situations include IBM, which is all uppercase, or McNeil, which has an uppercase letter in the third position. All state abbreviations are also handed by the capitalization maintenance function.

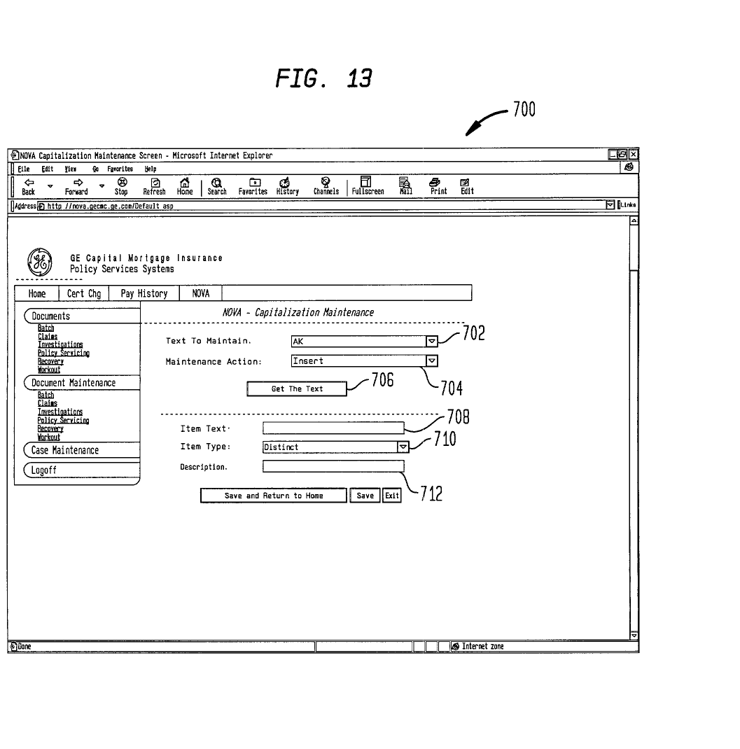

FIG. 13 shows a screenshot of a capitalization maintenance screen 700 according to the present invention. The Text to Maintain field provides a drop-down menu to select the text string that needs to be updated. The Maintenance Action field 704 provides a drop-down menu to select the maintenance action to be performed. These maintenance actions include View, Update, Insert, or Model After. The View function displays all information for the text in a non-editable format. The Update function displays all information for the text in an editable format. If the Insert function is selected, all the fields are blank for a new text. If the Model After function is selected, the fields are filled in from an existing text string, but will be saved for the new text string.

Once the text to maintain and maintenance action have been identified, the user clicks on the button labeled “Get the Text” 706. The Item Text box 708 shows the name of the text string that needs to look a certain way, such as IBM, McNeil, O'Hara, or the like. The Item Type box 710 is used to distinguish between a stand-alone string, which is identified as “Distinct” and a string forming the beginning of a longer string, which is identified as “Begin.” The Description box 712 is used to provide a description of the text string.

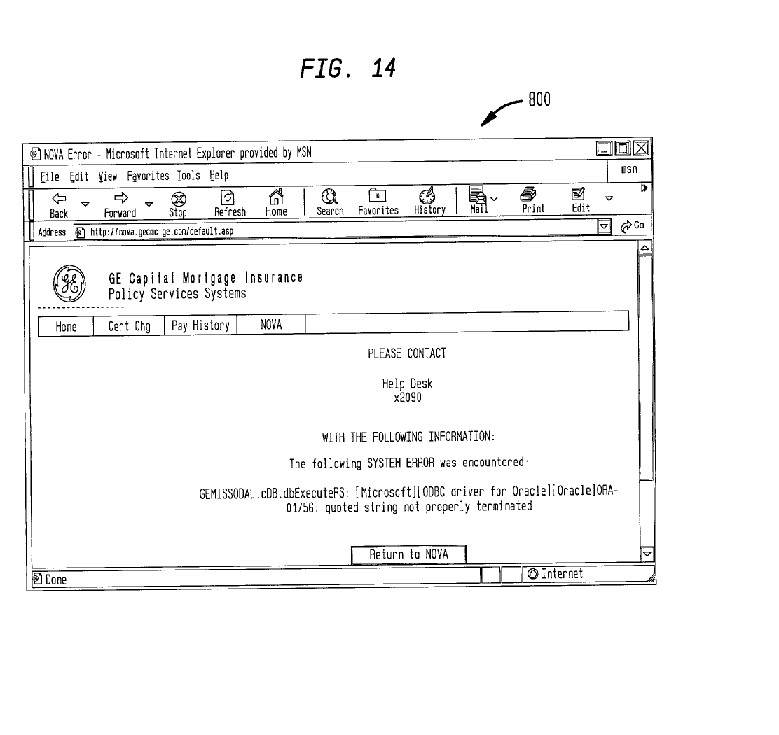

FIG. 14 shows a screenshot of an error screen 800 that appears whenever the NOVA system is not functioning properly. The error screen 800 provides contact information, and information identifying the particular error that has occurred.

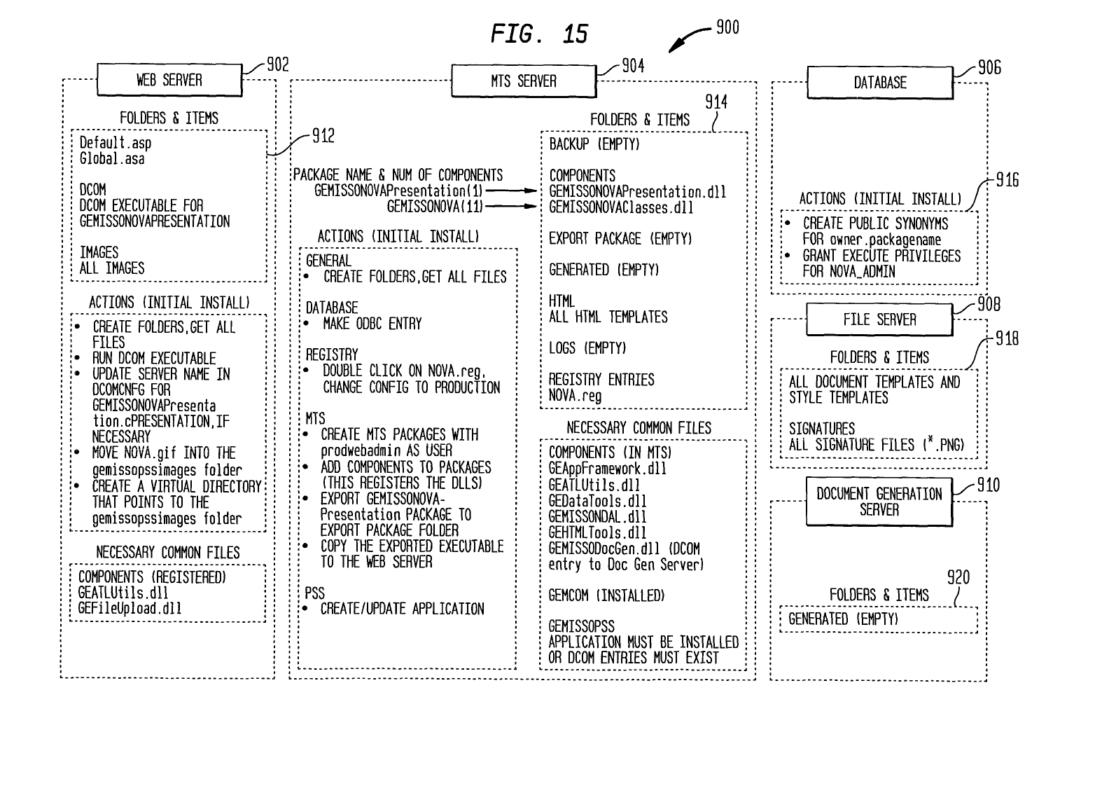

FIG. 15 is a software diagram illustrating a further aspect of the NOVA system 900. As shown in FIG. 15, the NOVA system software is distributed among a web server 902, an MTS server 904, a database 906, a file server 908, and a document generation server, all of which are connected to each other. The web server 902 is used to receive inputs from, and provide outputs to, a user of the system in the form of web pages. The inputs from the user are transmitted by the web server 902 to the MTS server 904, which accesses the database 906, file server 908, and document generation server 910 to perform the various functions of the NOVA system, described above. For each of these hardware components, FIGS. 15 lists folders & items stored on the component, actions to be performed at the component during initial installation, and necessary common files.

As illustrated in FIG. 15, the web server uses an Active Server Page to receive inputs from, and provide outputs to, the user. Thus, the folders and items 912 stored at the web server 902 include a default.asp file, as well as all images required for the web pages. As further illustrated in FIG. 15, the various COM objects required to perform the functions of the NOVA system are stored as two dynamic link libraries (DLLs), GEMISSONOVAPresentation.dll and GEMISSONOVAClasses.dll, which are included among the folders and items 914 stored at the MTS server 904. The database 906 contains customer data. As shown in FIG. 15, the database actions 916 including granting execute privileges for the NOVA system.

As further shown in FIG. 15, the filer server 908 is used to provide document templates, style templates, and signature files. These elements are included among the folders and items 918 stored at the file server 908. Finally, the document generation server 910 is used by the MTS server 904 to generate the requested document. The generated documents are among the elements included in the folders and items 920 stored at the document generation server 910.

The source code for the major software components of the present embodiment of the NOVA system is set forth in the attached Appendix.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A system for automatically generating correspondence, comprising:
a web server for generating web pages that are transmitted for remote viewing using a client browser, the generated web pages being configured to provide a user of the system with a document selection section for identifying a type of correspondence to be generated and an input variables section for identifying a subject of the correspondence;
a transaction server connected to the web server for receiving inputs from the web server and, in response to those inputs, automatically retrieving necessary data and a document template and, using the retrieved data and document template, generating a document that is transmitted back to the user for viewing and editing.

2. The system of claim 1, wherein the transaction server, in generating the document, accesses an electronic signature file and inserts a graphical image of the user's signature into the generated document.

3. The system of claim 1, wherein the transaction server, in response to an input by the user, generates an electronic document including a letterhead image.

4. The system of claim 1, wherein the transaction server, in response to an input by the user, generates an electronic document including a watermark.

5. The system of claim 1, wherein the transaction server, in response to an input from the user, faxes the generated document to a designated recipient.

6. The system of claim 1, wherein the transaction server, in response to an input from the user, e-mails the generated document to a designated recipient.

7. The system of claim 1, wherein the generated document may be printed as a hard copy for mailing to a designated recipient.

8. The system of claim 1, wherein, in response to an input from the user, the a document template may be modified.

9. The system of claim 1, wherein the system includes a capitalization table that is dynamically updated.

10. A method for automatically generating correspondence, comprising:
using a web server to generate web pages that are configured to provide a user of the system with a document selection section for identifying a type of correspondence to be generated and an input variables section for identifying a subject of the correspondence;
transmitting the generated web pages for remote viewing by a user using a client browser and for receiving from the user inputs identifying the type of correspondence to be generated and the subject of the correspondence;
in response to the user inputs, automatically retrieving necessary stored data and a stored document template; and
using the retrieved data and document template, generating a document that is transmitted back to the user for viewing and editing.

11. The method of claim 10, wherein the step of generating a document includes:
accessing an electronic signature file and inserting a graphical image of the user's signature into the generated document.

12. The method of claim 10, wherein the step of generating a document includes:
generating an electronic document including a letterhead image.

13. The method of claim 10, wherein the step of generating a document includes:
generating an electronic document including a watermark.

14. The method of claim 10, further including:
faxing the generated document to a designated recipient.

15. The system of claim 10, further including:
e-mailing the generated document to a designated recipient.

16. The system of claim 10, further including:
printing the generated document may be printed as a hard copy for mailing to a designated recipient.
